(19) United States
(12) Patent Application Publication
(10) Pub. No.: US 2018/0322476 A1
(43) Pub. Date: Nov. 8, 2018

(54) SERVICE FALLBACK METHOD AND APPARATUS

(71) Applicant: Alibaba Group Holding Limited, George Town (KY)

(72) Inventor: Xinjun WANG, Hangzhou (CN)

(73) Assignee: Alibaba Group Holding Limited, George Town (KY)

(21) Appl. No.: 16/026,986

(22) Filed: Jul. 3, 2018

Related U.S. Application Data
(63) Continuation of application No. PCT/CN2016/112022, filed on Dec. 26, 2016.

(30) Foreign Application Priority Data
Jan. 4, 2016 (CN) 201610006828.7

(51) Int. Cl. G06Q 20/10; G06Q 20/40; G06Q 20/38

(52) U.S. Cl. CPC G06Q 20/10; G06Q 20/381; G06Q 20/4014

(57) ABSTRACT

Techniques are described for processing international transaction refund. In an example implementation, a system receives a refund request for an international transaction associated with a foreign currency. In response to receiving the refund request, the system retrieves previously stored exchange rate information for the international transaction associated with the refund request. The exchange rate information includes an exchange rate between the foreign currency and a national currency that was in effect when the international transaction was originally processed. Moreover, the national currency amount for the international transaction based on the determined exchange rate information of the foreign currency is calculated. The calculated amount to the national currency based on the exchange rate information is automatically converted, which completes the refund request for the international transaction based on the calculated national currency amount.

This application is a continuation of PCT Application No. PCT/CN2016/112022, filed on Dec. 26, 2016, which claims priority to Chinese Patent Application No. 201610006828.7, filed on Jan. 4, 2016, and each application is hereby incorporated by reference in its entirety.

### TECHNICAL FIELD

The present application relates to the telecommunications field, and in particular, to a service fallback method and apparatus.

### BACKGROUND

When a user purchases a product with foreign currency, if the user wants to request for a refund after an international transaction, the international merchant usually refunds foreign currency to the user. The user logs in to an e-banking system to actively exchange the foreign currency to obtain Chinese RMB currency. The transaction is relatively cumbersome, and the exchange rate fluctuates. The user worries that a loss occurs after the refund due to issues such as purchasing of the foreign currency and the foreign currency transaction. Consequently, the user becomes less interested in purchasing the products with foreign currency.

### SUMMARY

The present application discloses a service fallback method, where the method includes: when receiving a service fallback request for a completed service, reading stored fallback reference information that corresponds to the service; calculating corresponding service fallback information based on the fallback reference information; and completing a service fallback for the service based on the calculated service fallback information.

Optionally, the method further includes: when receiving a service request for the service, reading the fallback reference information included in the service request; locally associating the fallback reference information with the service; and locally storing the fallback reference information.

Optionally, the service includes an international transaction service, the service fallback includes an international transaction refund, the fallback reference information includes exchange rate information for an international transaction, and the service fallback information includes a refund amount in the international transaction refund.

Optionally, when the service is an international transaction service, the service fallback is an international transaction refund. The fallback reference information is the exchange rate information for the international transaction, and the service fallback information is the refund amount in the international transaction refund. The calculating corresponding service fallback information based on the fallback reference information includes: converting a target amount of foreign currency into a corresponding amount of national currency based on the exchange rate information for the international transaction when a refund method selected by a user is a foreign currency amount-based refund; or converting a target amount of national currency into a corresponding amount of foreign currency based on the exchange rate information for the international transaction when a refund method selected by a user is a national currency amount-based refund, where the target amount is an amount actually paid in the international transaction.

Optionally, the completing a service fallback for the service based on the calculated service fallback information includes: when the refund method selected by the user is the foreign currency amount-based refund, deducting the target amount of foreign currency from an account of an international merchant, returning the target amount of foreign currency to a predetermined foreign currency fund pool, and returning the converted corresponding amount of national currency to the user by using an intermediate account; or when the refund method selected by the user is the national currency amount-based refund, deducting the converted corresponding amount of foreign currency from an account of an international merchant, returning the converted corresponding amount of foreign currency to a predetermined foreign currency fund pool, and returning the target amount of national currency to the user by using an intermediate account.

The present application further discloses a service fallback apparatus, where the apparatus includes: a first read module, configured to read stored fallback reference information that corresponds to the service when receiving a service fallback request for a completed service; a first calculation module, configured to calculate corresponding service fallback information based on the fallback reference information; and a first fallback module, configured to complete a service fallback for the service based on the calculated service fallback information.

Optionally, the apparatus further includes: a second read module, configured to read the fallback reference information included in the service request when receiving a service request for the service; and a first storage module, configured to locally associate the fallback reference information with the service and to locally store the fallback reference information.

Optionally, the service includes an international transaction service, the service fallback includes an international transaction refund, the fallback reference information includes exchange rate information for an international transaction, and the service fallback information includes a refund amount in the international transaction refund.

Optionally, when the service is an international transaction service, the service fallback is an international transaction refund, the fallback reference information is the exchange rate information for the international transaction, and the service fallback information is the refund amount in the international transaction refund. The first calculation module is specifically configured to convert a target amount of foreign currency into a corresponding amount of national currency based on the exchange rate information for the international transaction when a refund method selected by a user is a foreign currency amount-based refund; or convert a target amount of national currency into a corresponding amount of foreign currency based on the exchange rate information for the international transaction when a refund method selected by a user is a national currency amount-based refund, where the target amount is an amount actually paid in the international transaction.

Optionally, when the refund method selected by the user is the foreign currency amount-based refund, the first fallback module is specifically configured: to deduct the target amount of foreign currency from an account of an international merchant, to return the target amount of foreign currency to a predetermined foreign currency fund pool, and to return the converted corresponding amount of national currency to the user by using an intermediate account. When the refund method selected by the user is the national currency amount-based refund, the first fallback module is specifically configured: to deduct the converted corresponding amount of foreign currency from an account of an international merchant, to return the converted corresponding amount of foreign currency to a predetermined foreign currency fund pool, and to return the target amount of national currency to the user by using an intermediate account.

The present application further discloses an international transaction refund method, where the method includes: when receiving a refund request for a completed international transaction service, reading stored exchange rate information for an international transaction; calculating a refund amount in an international transaction refund based on the exchange rate information for the international transaction; and completing a refund for the international transaction service based on the calculated refund amount in the international transaction refund.

Optionally, the method further includes: when receiving a payment request for the international transaction service, reading exchange rate information for the international transaction included in the payment request; and locally associating the exchange rate information for the international transaction with the international transaction service, and locally storing the exchange rate information.

Optionally, calculating a refund amount in an international transaction refund based on the exchange rate information for the international transaction includes: converting a target amount of foreign currency into a corresponding amount of national currency based on the exchange rate information for the international transaction when a refund method selected by a user is a foreign currency amount-based refund; or converting a target amount of national currency into a corresponding amount of foreign currency based on the exchange rate information for the international transaction when a refund method selected by a user is a national currency amount-based refund, where the target amount is an amount actually paid in the international transaction.

Optionally, the completing a refund for the international transaction service based on the calculated refund amount in the international transaction refund includes: when the refund method selected by the user is the foreign currency amount-based refund, deducting the target amount of foreign currency from an account of an international merchant, returning the target amount of foreign currency to a predetermined foreign currency fund pool, and returning the converted corresponding amount of national currency to the user by using an intermediate account; or when the refund method selected by the user is the national currency amount-based refund, deducting the converted corresponding amount of foreign currency from an account of an international merchant, returning the converted corresponding amount of foreign currency to a predetermined foreign currency fund pool, and returning the target amount of national currency to the user by using an intermediate account.

The present application further discloses an international transaction refund apparatus, where the apparatus includes: a third read module, configured to read stored exchange rate information for an international transaction when receiving a refund request for a completed international transaction service; a second calculation module, configured to calculate a refund amount in an international transaction refund based on the exchange rate information for the international transaction; and a second fallback module, configured to complete a refund for the international transaction service based on the calculated refund amount in the international transaction refund.

Optionally, the apparatus further includes: a fourth read module, configured to read exchange rate information for the international transaction included in the payment request when receiving a payment request for the international transaction service; and a second storage module, configured to locally associate the exchange rate information for the international transaction with the international transaction service and to locally store the exchange rate information.

Optionally, the second calculation module is specifically configured to convert a target amount of foreign currency into a corresponding amount of national currency based on the exchange rate information for the international transaction when a refund method selected by a user is a foreign currency amount-based refund; or to convert a target amount of national currency into a corresponding amount of foreign currency based on the exchange rate information for the international transaction when a refund method selected by a user is a national currency amount-based refund, where the target amount is an amount actually paid in the international transaction.

Optionally, when the refund method selected by the user is the foreign currency amount-based refund, the second fallback module is specifically configured: to deduct the target amount of foreign currency from an account of an international merchant, to return the target amount of foreign currency to a predetermined foreign currency fund pool, and to return the converted corresponding amount of national currency to the user by using an intermediate account. When the refund method selected by the user is the national currency amount-based refund, the second fallback module is specifically configured: to deduct the converted corresponding amount of foreign currency from an account of an international merchant, to return the converted corresponding amount of foreign currency to a predetermined foreign currency fund pool, and to return the target amount of national currency to the user by using an intermediate account.

In the present application, when the service fallback request for the completed service is received, the stored fallback reference information that corresponds to the service is read, the corresponding service fallback information is calculated based on the fallback reference information, and the service fallback for the service is implemented based on the calculated service fallback information, thereby implementing an accurate service fallback based on the stored fallback reference information.

When the technical solution in the present application is applied to an international transaction, if the refund request for the completed international transaction service is received, the stored exchange rate information for the international transaction is read. The refund amount in the international transaction refund is calculated based on the exchange rate information for the international transaction. The refund for the international transaction service is completed based on the calculated refund amount in the international transaction refund, thereby implementing the refund for the international transaction based on the stored exchange rate information for the international transaction. It can prevent a loss caused by exchange rate fluctuation to the user in a refund procedure.

### BRIEF DESCRIPTION OF DRAWINGS

FIG. 1 is a flowchart illustrating a service fallback method according to an implementation of the present application;

FIG. 2 is a flowchart illustrating an international transaction refund method according to an implementation of the present application;

FIG. 3 is a flowchart illustrating a payment transaction in an international transaction according to an implementation of the present application;

FIG. 4 is a flowchart illustrating a refund transaction in an international transaction according to an implementation of the present application;

FIG. 5 is a logical block diagram illustrating a service fallback apparatus according to an implementation of the present application;

FIG. 6 is a structural diagram illustrating hardware of a serving endpoint that includes a service fallback apparatus according to an implementation of the present application;

FIG. 7 is a logical block diagram illustrating an international transaction refund apparatus according to an implementation of the present application;

FIG. 8 is a structural diagram of hardware of a serving endpoint that includes the international transaction refund apparatus according to an implementation of the present application; and

FIG. 9 is a flowchart illustrating an example of a computer-implemented method for processing an international refund request, according to an implementation of the present disclosure.

### DESCRIPTION OF EMBODIMENTS

The following describes the present application by using specific implementations and with reference to a specific application scenario.

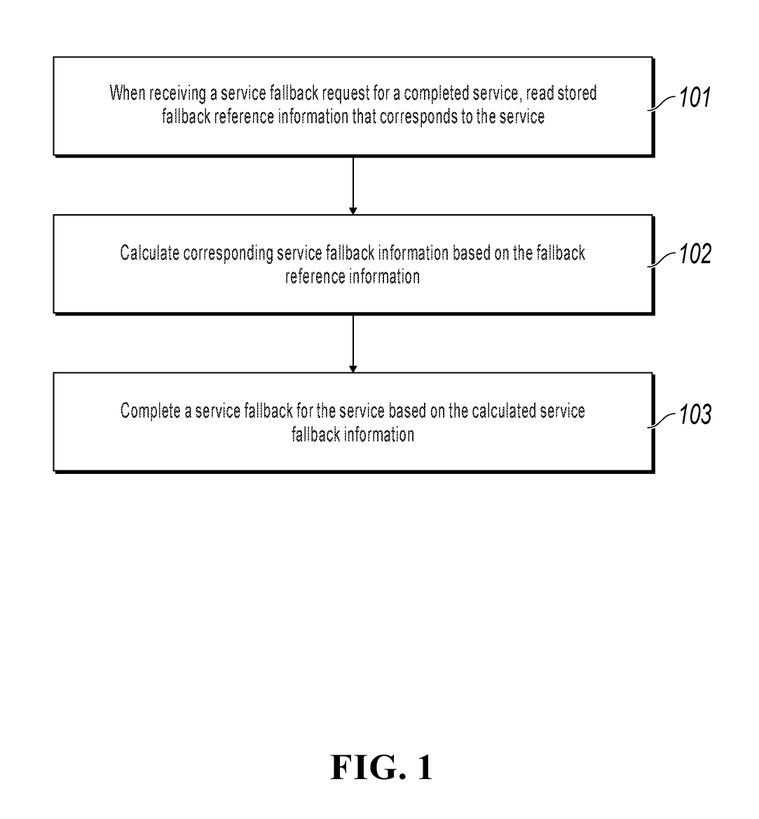

Referring to FIG. 1, FIG. 1 shows a service fallback method according to an implementation of the present application, applied to a serving endpoint, and the method includes the following steps:

Step 101: When receiving a service fallback request for a completed service, read stored fallback reference information that corresponds to the service.

Step 102: Calculate corresponding service fallback information based on the fallback reference information.

Step 103: Complete a service fallback for the service based on the calculated service fallback information.

The serving endpoint can include a server that provides a serving endpoint for a service client of a user, a server cluster, or a service platform established based on the server cluster. The client can include client software that provides a service for a user. The user can perform a predetermined operation on a service interface, provided by the client, to trigger the client to send a service request to the serving endpoint.

For example, when the service is an international transaction service, the client can be an Alipay client that provides an international transaction service for a user, the service interface can be a payment interface provided by the Alipay client, the serving endpoint can be an Alipay platform that provides a service for the Alipay client of the user, and the service peer endpoint can be an international e-commerce platform.

When purchasing a product with foreign currency, a user can perform a predetermined operation on the payment interface, provided by the Alipay client, to trigger the Alipay client to send a payment request to the Alipay platform. Generally, the predetermined operation can include an operation of confirming a payment order of a purchased foreign product by the user. For example, a confirmation button for confirming payment can be provided on the payment interface. After the user confirms an amount and a product with the order, the user can tap the confirmation button to trigger the Alipay client to send a payment request to the Alipay platform.

In this example, when sending the service request to the serving endpoint, the client can add the fallback reference information to the service request. After the service is performed, when the user re-sends a service fallback request for the service to the serving endpoint by using the client, the serving endpoint can perform a service fallback operation on the completed service based on the fallback reference information.

The fallback reference information can be obtained after the client queries the service peer endpoint. Before sending the service request to the serving endpoint, the client can send a query request used to query fallback reference information to the service peer endpoint. After receiving the query request, the service peer endpoint can return the fallback reference information to the client. After receiving the fallback reference information returned by the service peer endpoint, the client can present the fallback reference information to the user on the service interface.

In addition, it should be noted that the fallback reference information can be independently set by the service peer endpoint, or can be obtained after negotiation between the client and the service peer endpoint through message exchange.

For example, when the service is an international transaction service, the fallback reference information can be exchange rate information for an international transaction. Before initiating a payment request to the Alipay platform, the Alipay client can send a transaction exchange rate query request to an international e-commerce platform. After receiving the query request, the international e-commerce platform can directly obtain a current exchange rate, set the obtained current exchange rate as the transaction exchange rate, and return the transaction exchange rate to the Alipay client. Alternatively, before the Alipay client initiates the payment request to the Alipay platform, the user can negotiate with a remote international merchant by using an instant chat tool, provided by the Alipay client, to determine the transaction exchange rate. After negotiation is completed, the international e-commerce platform can set the transaction exchange rate based on a negotiation result, and return the transaction exchange rate to the Alipay client. After receiving the transaction exchange rate, the Alipay client can present the transaction exchange rate to the user on the payment interface, to instruct the user to complete payment based on the transaction exchange rate.

In this example, after receiving the service request sent by the client, the serving endpoint can read the fallback reference information included in the service request, locally associate the fallback reference information with the service corresponding to the service request, and locally store the fallback reference information, to help query the fallback reference information in a subsequent service fallback for the service.

After locally storing the fallback reference information included in the service request, the serving endpoint can perform interaction with a corresponding service peer endpoint based on the received service request, to complete the service.

For example, when the service is an international transaction service, after receiving the international transaction payment request initiated by the Alipay client, the Alipay platform can perform foreign currency purchasing and a foreign currency transaction based on a payment amount included in the payment request, and send transaction information to the international e-commerce platform, to complete a payment transaction.

In this example, after the service is performed, the user can further initiate, to the serving endpoint, a service fallback for the completed service by using the client. When the user performs a service fallback on the completed service, the user can perform a predetermined operation on a service interface provided by the client, to trigger the client to send the service fallback request for the completed service to the serving endpoint.

After receiving the service fallback request sent by the client, the serving endpoint can read a stored service fallback parameter associated with the service, and then calculate corresponding service fallback information based on the service fallback parameter. The service fallback information can include information or a parameter required for successfully completing a service fallback for the service. After calculating the corresponding service fallback information based on the service fallback parameter, the serving endpoint can complete a service fallback operation on the completed service based on the calculated service fallback information.

For example, when the service is an international transaction service, the service fallback can include an international transaction refund, and the service fallback information can include a refund amount in the international transaction refund. If a user dislikes a product and wants to request for a refund after the user successfully purchases the product with foreign currency, the user can perform a predetermined operation on a payment interface, provided by the Alipay client, to trigger the Alipay client to send a refund request to the Alipay platform. Generally, the predetermined operation can include an operation of confirming a refund for a completed order by the user. For example, a confirmation button for confirming the refund can be provided on a refund interface, and after checking a refund amount in the order, the user can tap the confirmation button, to trigger the Alipay client to send the refund request to the Alipay platform. After receiving the refund request, the Alipay platform can read a stored transaction exchange rate associated with the completed order for the international transaction, and then calculate an actual refund amount based on the transaction exchange rate. After calculating the actual refund amount based on the transaction exchange rate, the serving endpoint can complete an international refund transaction for the completed order based on the calculated refund amount.

It can be seen that, as such, when a service is initiated, fallback reference information used for a service fallback can be included in a service request, and the serving endpoint can store the fallback reference information. After the service is completed, when a user initiates a fallback for the completed service, the serving endpoint can read the stored fallback reference information to complete a service fallback for the completed service, thereby accurately completing a service fallback based on the stored fallback reference information.

The technical solution of the present application is described below: the service is an international transaction service, the client is an Alipay client, and the serving endpoint is an Alipay platform with reference to an international transaction.

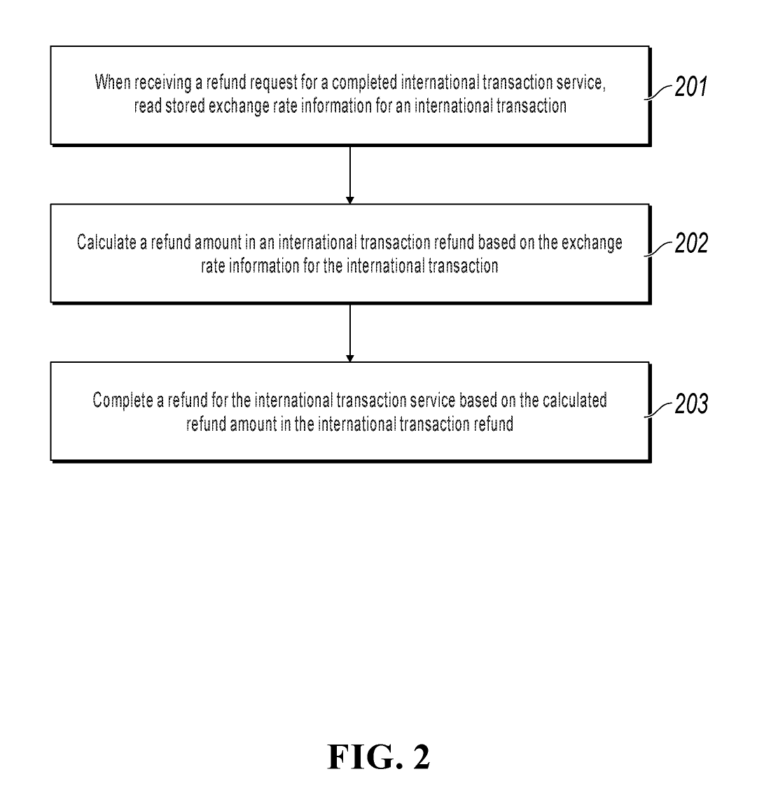

Referring to FIG. 2, FIG. 2 shows an international transaction refund method for an international transaction according to an implementation of the present application. The method can be performed by a serving endpoint, and the method includes the following steps:

Step 201: When receiving a refund request for a completed international transaction service, read stored exchange rate information for an international transaction.

Step 202: Calculate a refund amount in an international transaction refund based on the exchange rate information for the international transaction.

Step 203: Complete a refund for the international transaction service based on the calculated refund amount in the international transaction refund.

The client can be an Alipay client that provides an international transaction service for a user, the service interface can be a payment interface provided by the Alipay client, the serving endpoint can be an Alipay platform that provides a service for the Alipay client of the user, and the service peer endpoint can be an international e-commerce platform (for example, an Amazon e-commerce platform).

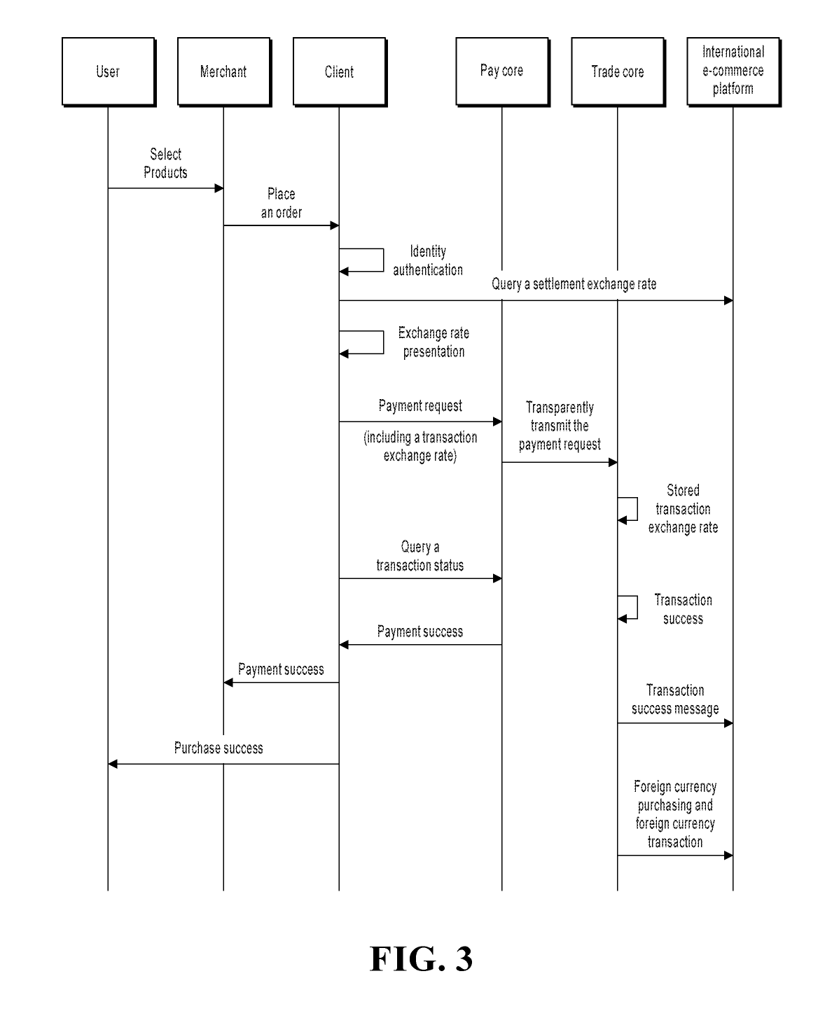

Referring to FIG. 3, FIG. 3 is a flowchart illustrating an international payment transaction according to this implementation.

Referring to FIG. 3, when purchasing a product with foreign currency, a user can place an order for a selected product with foreign currency on an international e-commerce platform. After the user places an order, the e-commerce platform can authenticate an identity of the user, to ensure that the operation is performed by the user. For example, the e-commerce platform can send a verification code based on a mobile number reserved by the user. After the user successfully enters the verification code on the user interface, identity authentication succeeds. After identity authentication of the user succeeds, the user can request to the e-commerce platform for a payment transaction.

In a user interface of the international e-commerce platform, the payment platforms, including the Alipay platform, can be provided in advance to cooperate with the e-commerce platform. When the user applies for a payment transaction, the user can select Alipay on the user interface to perform the payment transaction.

When the user selects Alipay to perform the payment transaction, the international e-commerce platform can jump from a current user interface to a payment interface of the Alipay client. On the payment interface, information such as order information, product information, and a transaction amount related to the current payment transaction is presented to the user for check by the user.

Still referring to FIG. 3, after the international e-commerce platform jumps to the payment interface of the Alipay client, the Alipay client can further initiate a transaction exchange rate query to the international e-commerce platform in the background. For example, the Alipay client can send a transaction exchange rate query request to the e-commerce platform in background. After receiving the query request, the e-commerce platform can return a corresponding transaction exchange rate to the Alipay client.

The transaction exchange rate can be independently set by the international e-commerce platform or can be obtained after negotiation between a user and a remote international merchant through message exchange.

For example, in a shown implementation, after receiving the transaction exchange rate query request, the international e-commerce platform can directly obtain a current exchange rate, set the obtained exchange rate as a transaction exchange rate, and return the transaction exchange rate to the Alipay client. In another shown implementation, the user can negotiate with a remote international merchant by using an instant chat tool provided by the Alipay client or by the international e-commerce platform, to determine the transaction exchange rate. After negotiation is completed, the international e-commerce platform can set the transaction exchange rate based on a negotiation result and return the transaction exchange rate to the Alipay client.

Still referring to FIG. 3, after receiving the transaction exchange rate returned by the international e-commerce platform, the Alipay client can present the transaction exchange rate to the user on the payment interface, to instruct the user to complete payment based on the transaction exchange rate.

In addition, a confirmation button for confirming payment can be provided on the payment interface in advance. After checking an amount and a product with the order, the user taps the confirmation button to trigger the Alipay client to send the payment request to the Alipay platform.

When sending the payment request to the Alipay platform, the Alipay client can add the obtained transaction exchange rate to the payment request. For example, the Alipay client can gather the transaction exchange rate into a specified format to be included in an extended field of the payment request and send the payment request to the Alipay platform. After payment for the order is completed, when the user initiates the Alipay platform again by using the Alipay client to request a refund for the order, the Alipay platform can perform a corresponding refund operation based on the transaction exchange rate.

Still referring to FIG. 3, in a shown implementation, the Alipay platform can be divided into a paycore (payment core) subsystem and a tradecore (trade core) subsystem. The paycore subsystem is configured to process an order for a user, receive a payment request sent by the Alipay client and to transparently transmit the received payment request to the tradecore subsystem. The tradecore subsystem is configured to interact with an international e-commerce platform, based on the payment request transparently transmitted by the paycore subsystem, to complete a payment transaction and to complete a refund transaction when the user applies for a refund.

Certainly, in actual application, in addition to the paycore subsystem and the tradecore subsystem, the Alipay platform can be divided into another type of subsystem based on an actual service requirement. This is not limited in the present application.

Still referring to FIG. 3, when receiving the payment request sent by the Alipay client, the paycore subsystem can transparently transmit the payment request to the tradecore subsystem. After receiving the payment request, the tradecore system can read the transaction exchange rate included in the payment request, locally associate the transaction exchange rate with an order corresponding to the payment request, and then locally store the transaction exchange rate, to help query the transaction exchange rate in a subsequent international transaction refund for the order.

After locally storing the transaction exchange rate included in the payment request, the tradecore subsystem can locally complete a payment transaction based on the received payment request. For example, the tradecore subsystem can deduct a payment transaction amount in the payment request from an RMB account of the user. After the payment transaction is locally completed, the order transaction succeeds.

Referring to FIG. 3, after the order transaction succeeds, the Alipay client can send a query message to the paycore subsystem to query a current transaction status of the order. Because the order transaction has succeeded, after learning from the tradecore subsystem that the order transaction has succeeded, the paycore subsystem can return a payment success notification to the Alipay client. After receiving the notification, the Alipay client can send a payment success notification to a merchant by using the e-commerce platform and can send a purchase success notification to the user.

Still referring to FIG. 3, after the order transaction succeeds, the tradecore subsystem can further send a transaction success message to the international e-commerce platform, perform operations of foreign currency conversion and foreign currency purchasing, convert a successfully transacted amount into a corresponding amount of foreign currency, and transfer the amount of foreign currency to the remote international merchant. After transfer is completed, the current payment transaction is completed.

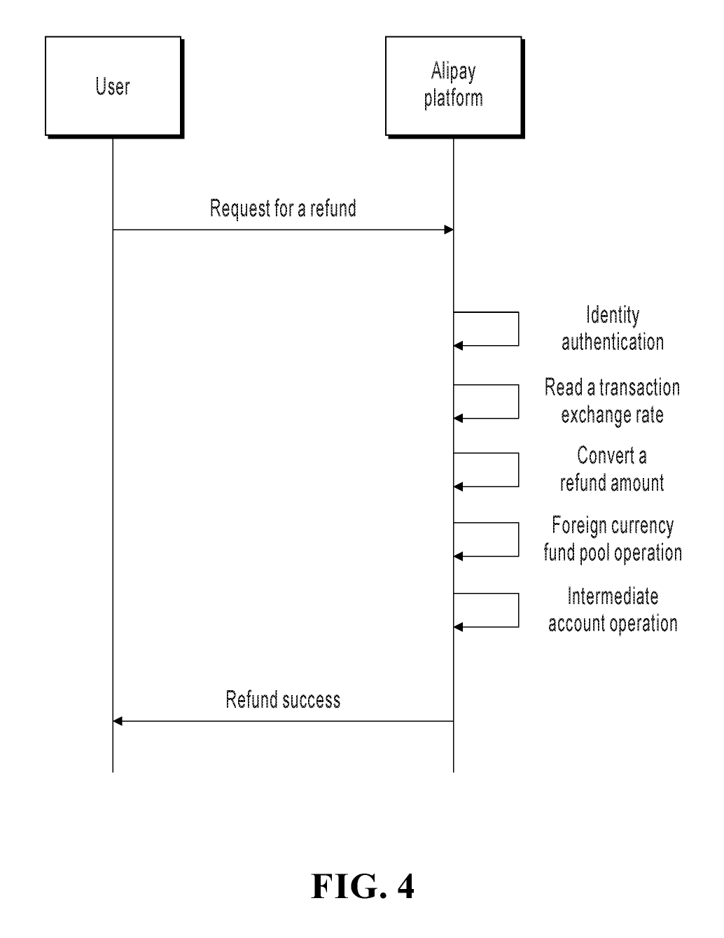

Referring to FIG. 4, FIG. 4 is a flowchart illustrating an international refund transaction according to this implementation.

Referring to FIG. 4, after a user successfully purchases a foreign currency product, if the user dislikes the product and wants to request for a refund, the user can initiate a refund to the Alipay platform by using the Alipay client.

The Alipay client or the e-commerce platform can provide a refund interface for the user. On the refund interface, the user can present an amount of a current refund and product information. In addition, on the refund interface, a confirmation button for confirming a refund can be provided. After the user checks a refund amount of an order, the user can tap the confirmation button, to trigger the Alipay client to send a refund request to the Alipay platform.

Still referring to FIG. 4, after the Alipay platform receives the refund request, the Alipay platform can still authenticate an identity of the user, to determine whether the operation is performed by the user. After identity authentication of the user succeeds, the Alipay platform can read a stored transaction exchange rate associated with the completed order for a payment transaction and then calculate an actual refund amount based on the transaction exchange rate.

When initiating the refund, the user can select a refund method. In implementation, refund methods that can be selected by the user can be provided on the refund interface. In a shown implementation, the refund methods provided on the refund interface can include a foreign currency amount-based refund, and an RMB amount-based refund (in this example, RMB is the national currency). When initiating the refund, the user can select a favorite refund method on the refund interface.

On one hand, when the user selects the foreign currency amount-based refund on the refund interface, the Alipay platform can directly deduct a target amount of foreign currency from an account of a remote international merchant, and return the foreign currency to a predetermined foreign currency fund pool. The target amount is an amount actually paid when the user performs a payment transaction for the order. For example, when the user performs a payment transaction for a product that costs one dollar, if the user pays RMB 6.3, a target amount of foreign currency paid by the user is one dollar, and a target amount of RMB paid by the user is RMB 6.3.

When the target amount of foreign currency is deducted from the account of the remote international merchant, and is returned to the predetermined foreign currency fund pool, a refund procedure for the remote international merchant is completed. Because a whole procedure is irrelevant to a current exchange rate, no loss occurs to the merchant.

After the refund procedure for the remote international merchant is completed, the Alipay platform can read the stored transaction exchange rate associated with the order, convert the target amount foreign currency of into a corresponding amount of RMB based on thetransaction exchange rate, and return the converted RMB to an account of the user by using an intermediate account. After the converted RMB is successfully returned to the account of the user, a refund procedure for the user is completed. Because a whole procedure is irrelevant to the current exchange rate, no loss occurs to the user.

On the other hand, when the user selects an RMB amount-based refund on the refund interface, the Alipay platform can read the stored transaction exchange rate associated with the order, and convert a target amount of RMB into a corresponding amount of foreign currency based on the transaction exchange rate, and then the Alipay platform can deduct the converted corresponding amount of foreign currency from the account of the remote international merchant, and return the converted corresponding amount of foreign currency to the predetermined foreign currency fund pool. In this case, the refund procedure for the remote international merchant is completed. Because a whole procedure is irrelevant to the current exchange rate, no loss occurs to the merchant.

When the refund procedure for the remote international merchant is completed, the Alipay platform can return the target amount of RMB to the account of the user by using the intermediate account. In this case, the target amount of RMB is an amount of RMB actually paid when the user performs the payment transaction for the order. After the target amount of RMB is successfully returned to the account of the user, the refund procedure for the user is completed. Because a whole procedure is irrelevant to the current exchange rate, no loss occurs to the user.

So far, the whole refund procedure endpoints. In the whole refund procedure, the refund is performed based on the transaction exchange rate used by the user to perform a payment transaction, and is irrelevant to the current exchange rate. Therefore, loss is caused to neither the merchant nor the user. In addition, in the whole refund procedure, a refund procedure for the international merchant is completed by using a foreign currency fund pool, a refund return procedure for the user is completed by using an intermediate account, and the foreign currency fund pool and the intermediate account are independent of each other. Therefore, no loss occurs to the Alipay platform, and the user does not need to perform cumbersome operations of foreign currency conversion and foreign currency purchasing, thereby improving user experience.

It can be seen that, as such, when the user performs the refund on the foreign product, the user neither needs to perform operations of foreign currency purchasing and foreign currency conversion, nor needs to worry about a loss caused by exchange rate fluctuation. Therefore, it easily resolves an exchange rate conversion problem for the user and causes no fund loss to the user, and the user becomes more interested in purchasing the foreign product.

In the above implementation, when the service fallback request for the completed service is received, the stored fallback reference information that corresponds to the service is read, the corresponding service fallback information is calculated based on the fallback reference information, and the service fallback for the service is implemented based on the calculated service fallback information, thereby implementing an accurate service fallback based on the stored fallback reference information.

When the technical solution in the above implementation is applied to a international transaction, if the refund request for the completed international transaction service is received, the stored exchange rate information for the international transaction is read, the refund amount in the international transaction refund is calculated based on the exchange rate information for the international transaction, and the refund for the international transaction service is completed based on the calculated refund amount in the international transaction refund, thereby implementing the refund for the international transaction based on the stored exchange rate information for the international transaction. It can prevent a loss caused by exchange rate fluctuation to the user in a refund procedure.

Corresponding to the above method implementation, the present application further provides an apparatus implementation.

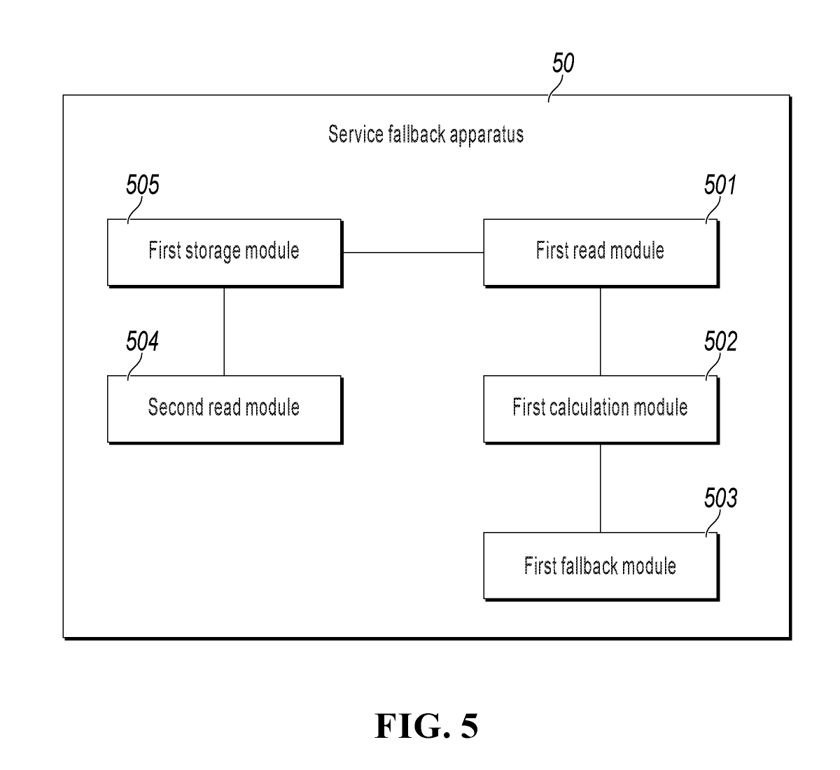

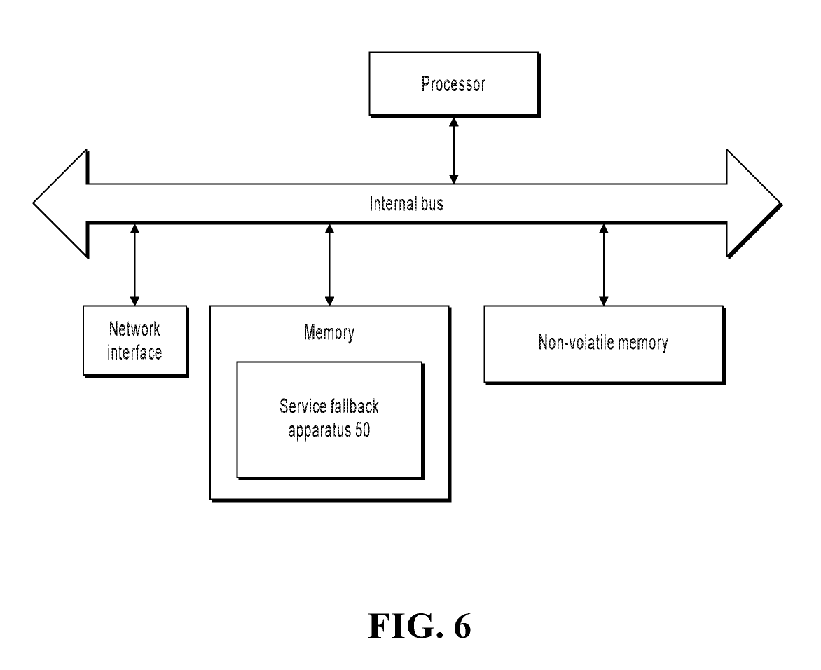

Referring to FIG. 5, the present application discloses a service fallback apparatus 50, applied to a serving endpoint. Referring to FIG. 6, a hardware architecture of a serving endpoint that includes the service fallback apparatus 50 generally includes a processor (CPU), a memory, a nonvolatile memory, a network interface, an internal bus, etc. In an example that the service fallback apparatus 50 is implemented by software, the service fallback apparatus 50 can be generally understood as a computer program loaded in the memory, and forms a logical software and hardware combined apparatus after running by using the CPU. The apparatus 50 includes: a first read module 501, configured to read stored fallback reference information that corresponds to the service when receiving a service fallback request for a completed service; a first calculation module 502, configured to calculate corresponding service fallback information based on the fallback reference information; and a first fallback module 503, configured to complete a service fallback for the service based on the calculated service fallback information.

In this example, the apparatus 50 can further include: a second read module 504, configured to read the fallback reference information included in the service request when receiving a service request for the service; and a first storage module 505, configured to locally associate the fallback reference information with the service and to locally store the fallback reference information.

In this example, the service can include an international transaction service; the service fallback can include an international transaction refund; the fallback reference information can include exchange rate information for an international transaction; and the service fallback information can include a refund amount in the international transaction refund.

In this example, when the service is an international transaction service, the service fallback is an international transaction refund, the fallback reference information is the exchange rate information for the international transaction, and the service fallback information is the refund amount in the international transaction refund, the first calculation module 502 is specifically configured to convert a target amount of foreign currency into a corresponding amount of national currency based on the exchange rate information for the international transaction when a refund method selected by a user is a foreign currency amount-based refund. Alternately, it is configured to convert a target amount of national currency into a corresponding amount of foreign currency based on the exchange rate information for the international transaction when a refund method selected by a user is a national currency amount-based refund.

The target amount is an amount actually paid in the international transaction.

In this example, when the service is an international transaction service, the service fallback is an international transaction refund, the fallback reference information is the exchange rate information for the international transaction, and the service fallback information is the refund amount in the international transaction refund. When the refund method selected by the user is the foreign currency amount-based refund, the first fallback module 503 is specifically configured to deduct the target amount of foreign currency from an account of an international merchant, return the target amount of foreign currency to a predetermined foreign currency fund pool, and return the converted corresponding amount of national currency to the user by using an intermediate account. When the refund method selected by the user is the national currency amount-based refund, the first fallback module 503 is configured to deduct the converted corresponding amount of foreign currency from an account of an international merchant, return the converted corresponding amount of foreign currency to a predetermined foreign currency fund pool, and return the target amount of national currency to the user by using an intermediate account.

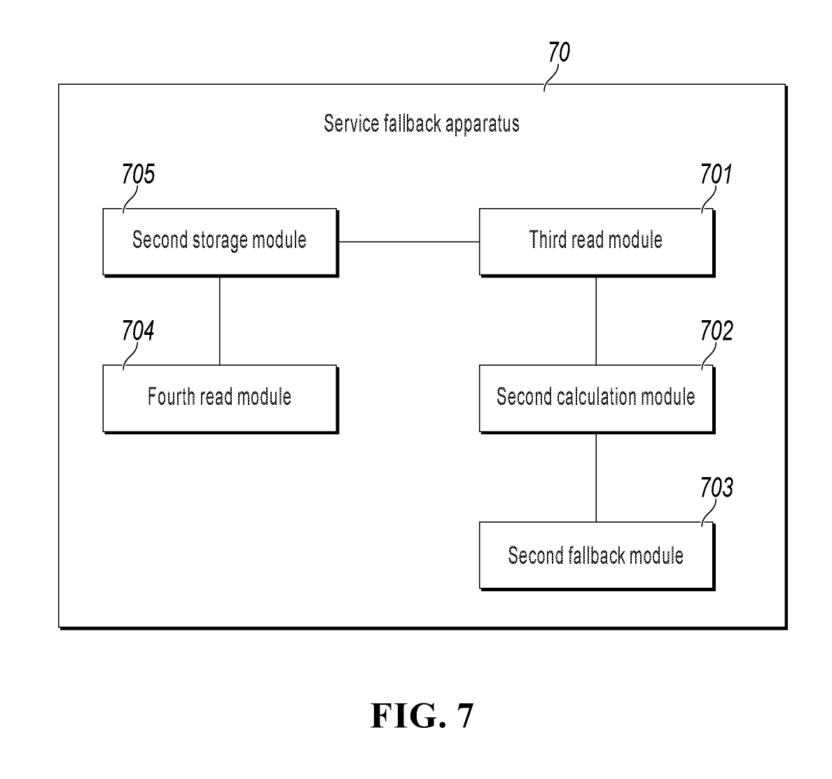

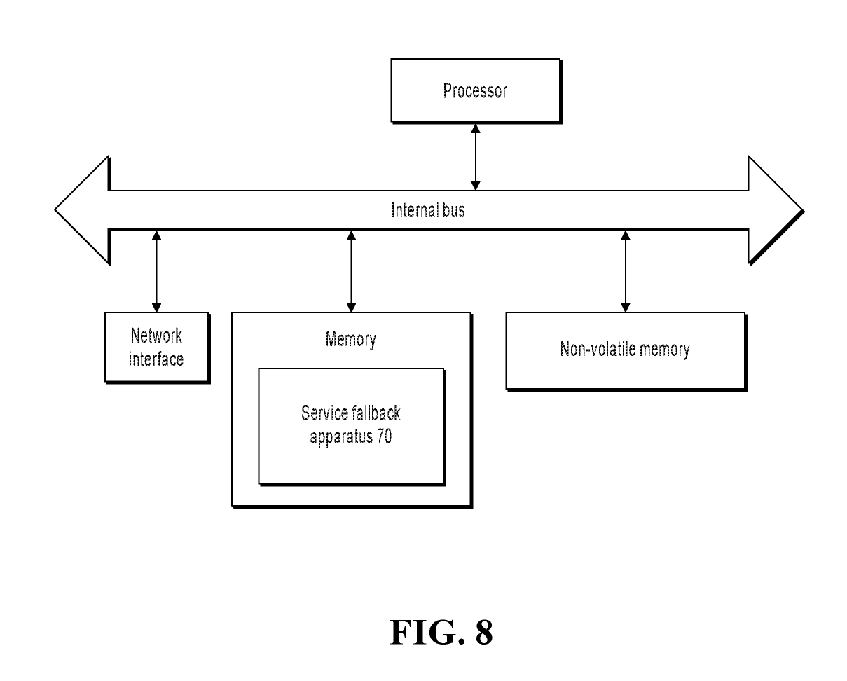

Referring to FIG. 7, the present application discloses an international transaction refund apparatus 70, applied to a serving endpoint. Referring to FIG. 8, a hardware architecture of a serving endpoint that includes the service fallback apparatus 70 generally includes a CPU, a memory, a nonvolatile memory, a network interface, an internal bus, etc. In an example that the international transaction refund apparatus 70 is implemented by software, the service fallback apparatus 70 can be generally understood as a computer program loaded in the memory, and forms a logical software and hardware combined apparatus after running by using the CPU. The apparatus 70 includes: a third read module 701, configured to read stored exchange rate information for an international transaction when receiving a refund request for a completed international transaction service; a second calculation module 702, configured to calculate a refund amount in an international transaction refund based on the exchange rate information for the international transaction; and a second fallback module 703, configured to complete a refund for the international transaction service based on the calculated refund amount in the international transaction refund.

In this example, the apparatus 70 can further include: a fourth read module 704, configured to read exchange rate information, for the international transaction, included in the payment request when receiving a payment request for the international transaction service; and a second storage module 705, configured to locally associate the exchange rate information for the international transaction with the international transaction service and to locally store the exchange rate information.

In this example, the second calculation module 702 is specifically configured to convert a target amount of foreign currency into a corresponding amount of national currency based on the exchange rate information for the international transaction when a refund method selected by a user is a foreign currency amount-based refund; or convert a target amount of national currency into a corresponding amount of foreign currency based on the exchange rate information for the international transaction when a refund method selected by a user is a national currency amount-based refund.

The target amount is an amount actually paid in the international transaction.

In this example, when the refund method selected by the user is the foreign currency amount-based refund, the second fallback module 703 is specifically configured to deduct the target amount of foreign currency from an account of an international merchant, return the target amount of foreign currency to a predetermined foreign currency fund pool, and return the converted corresponding amount of national currency to the user by using an intermediate account. When the refund method selected by the user is the national currency amount-based refund, the second fallback module 703 is configured to deduct the converted corresponding amount of foreign currency from an account of an international merchant, return the converted corresponding amount of foreign currency to a predetermined foreign currency fund pool, and return the target amount of national currency to the user by using an intermediate account.

A person skilled in the art can easily figure out another implementation solution of the present disclosure after considering the specification and practicing the present disclosure. The present application is intended to cover any variations, functions, or adaptive changes of the present application. These variations, functions, or adaptive changes comply with general principles of the present application, and include common knowledge or a commonly used technical means in the technical field that is not disclosed in the present application. The specification and the implementations are merely considered as examples, and the actual scope and the spirit of the present application are pointed out by the following claims.

It should be understood that the present application is not limited to the accurate structures that are described above and that are shown in the accompanying drawings, and modifications and changes can be made without departing from the scope of this disclosure. The scope of the present application is limited by the appended claims.

The above descriptions are merely examples of implementations of the present application, but are not intended to limit the present application. Any modification, equivalent replacement, or improvement made without departing from the spirit and principle of the present application should fall within the protection scope of the present application.

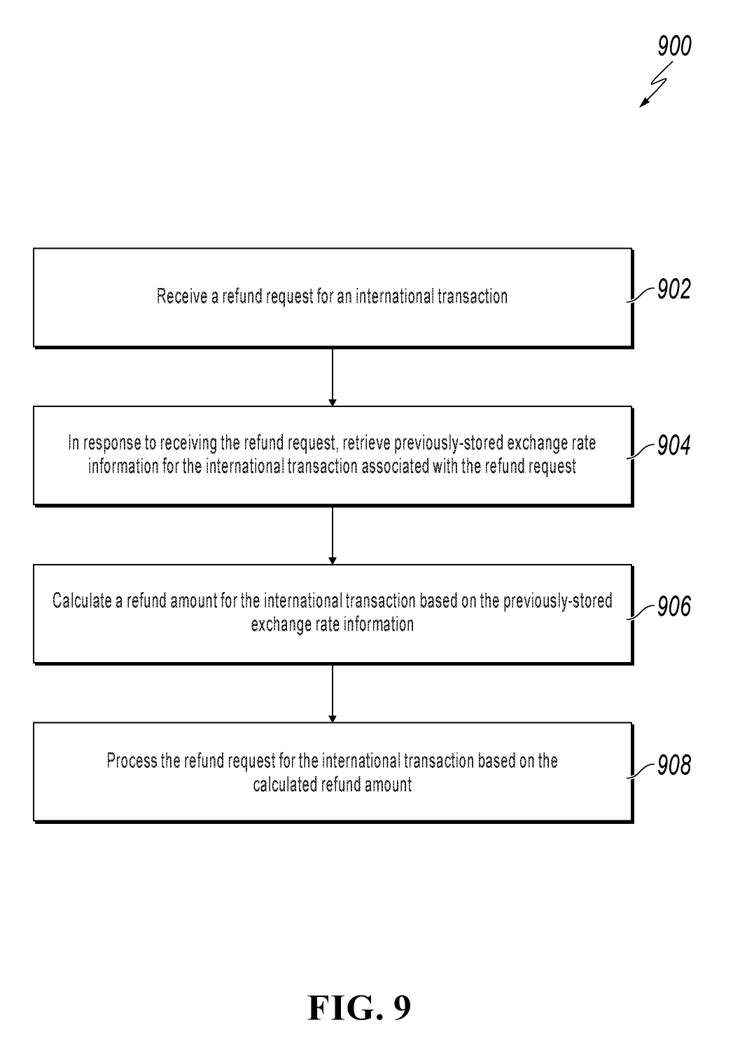

FIG. 9 is a flowchart illustrating an example of a computer-implemented method 900 for processing an international refund request, according to an implementation of the present disclosure. For clarity of presentation, the description that follows generally describes method 900 in the context of the other figures in this description. However, it will be understood that method 900 can be performed, for example, by any system, environment, software, and hardware, or a combination of systems, environments, software, and hardware, as appropriate. In some implementations, various steps of method 900 can be run in parallel, in combination, in loops, or in any order.

At 902, a refund request for an international transaction is received. In some implementations, the refund request is initiated through the online platform (such as, the Alipay platform) or directly through the international e-commerce platform where the transaction was originally processed. In some implementations, the refund request is a foreign currency refund request. In another implementation, the refund request is a national currency refund request. From 902, method 900 proceeds to 904.

At 904, in response to receiving the refund request, previously-stored exchange rate information for the international transaction associated with the refund request is retrieved. The exchange rate information includes, but not limited to, an exchange rate between the foreign currency and a national currency that was in effect when the international transaction was originally processed. In some implementations, the exchange rate between the foreign currency and the national currency is set by an international e-commerce platform or after negotiation between a user and an international merchant. From 904, method 900 proceeds to 906.

At 906, a refund amount for the international transaction based on the determined exchange rate information of the foreign currency is calculated. When calculating the amount for refund, the user has the option to select foreign currency based refund, national currency based refund, or other forms of currency based refund. If the refund request is a foreign currency refund request, convert a target amount of foreign currency into a corresponding amount of national currency based on the exchange rate information for the international transaction. If the refund request is a national currency refund request, convert a target amount of national currency into a corresponding amount of foreign currency based on the exchange rate information for the international transaction. The target amount is the amount originally processed in a payment request for the international transaction. In some implementation, the calculated refund amount is the amount in national currency originally paid in the international transaction. Moreover, the exchange rate information used for calculation is the exchange rate information when the international transaction was originally processed. Thus, the refund amount to the user is the national currency amount user originally paid in the international transaction. From 906, method 900 proceeds to 908.

At 908, the refund request for the international transaction based on the calculated refund amount is processed. In some aspects, processing the refund request for the international transaction includes, but not limited to, crediting an account specified in the refund request for the refund amount. In some implementations, when the foreign currency based refund is selected, the target amount of foreign currency is deducted from an account of an international merchant. The target amount of foreign currency is transferred to a predetermined foreign currency fund pool. Further, the converted amount of national currency corresponding to the target amount of foreign currency is returned to the user by using an intermediate account. In some cases, when the national currency based refund is selected, the converted amount of foreign currency corresponding to the target amount of national currency is deducted from the account of the international merchant. The converted amount of foreign currency is transferred to a predetermined foreign currency fund pool. Moreover, the target amount of national currency is returned to the user by using the intermediate account. After 908, method 900 stops.

Implementations of the subject matter described in this specification can realize particular advantages or technical effects. For example, implementations of the subject matter permit enhancement to transaction services (e.g., by increasing security, accuracy, transmission speed, or transmission efficiency). Further, implementations of the subject matter improve the process of international transactions between a buyer and a seller. In some implementations, the buyer initiates a request (for example, a payment request or a refund request) from a computing device, and the request is sent to a server (for example, a backend server) for processing. In an international transaction, the server receives the request for the international transaction associated with the currency used by the buyer. After the server the exchange rate information retrieved, the server processes the request for the international transaction. In some implementations, the request is transmitted, using a network protocol, by a networking device to the server. The server can include, but is not limited to, physical, virtual, or a combination of physical and virtual servers (for example, a cloud service, workstation, mobile computing device, and hardware or software computing devices).

The described methodology permits enhancement of various computing device transactions and overall transactions between international accounts. Participants in account transactions can be confident with accuracy and security of account information and performed transactions associated with the account information. The enhancement of account functionalities can provide automatic, secure interactions between the buyer and the seller.

In some implementations, one or more particular elements of a graphical user interface associated with the described methodology can be grouped, positioned, or arranged to be unobtrusive for a user. For example, the one or more elements can be positioned in such a way so as to obscure the least amount of data possible and to avoid covering any critical or often-used graphical user interface elements).

Embodiments and the operations described in this specification can be implemented in digital electronic circuitry, or in computer software, firmware, or hardware, including the structures disclosed in this specification or in combinations of one or more of them. The operations can be implemented as operations performed by a data processing apparatus on data stored on one or more computer-readable storage devices or received from other sources. A data processing apparatus, computer, or computing device may encompass apparatus, devices, and machines for processing data, including by way of example a programmable processor, a computer, a system on a chip, or multiple ones, or combinations, of the foregoing. The apparatus can include special purpose logic circuitry, for example, a central processing unit (CPU), a field programmable gate array (FPGA) or an application-specific integrated circuit (ASIC). The apparatus can also include code that creates an execution environment for the computer program in question, for example, code that constitutes processor firmware, a protocol stack, a database management system, an operating system (for example an operating system or a combination of operating systems), a cross-platform runtime environment, a virtual machine, or a combination of one or more of them. The apparatus and execution environment can realize various different computing model infrastructures, such as web services, distributed computing and grid computing infrastructures.

A computer program (also known, for example, as a program, software, software application, software module, software unit, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A program can be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program can be executed on one computer or on multiple computers that are located at one site or distributed across multiple sites and interconnected by a communication network.

Processors for execution of a computer program include, by way of example, both general- and special-purpose microprocessors, and any one or more processors of any kind of digital computer. Generally, a processor will receive instructions and data from a read-only memory or a random-access memory or both. The elements of a computer are a processor for performing actions in accordance with instructions and one or more memory devices for storing instructions and data. Generally, a computer will also include, or be operatively coupled to receive data from or transfer data to, or both, one or more mass storage devices for storing data. A computer can be embedded in another device, for example, a mobile device, a personal digital assistant (PDA), a game console, a Global Positioning System (GPS) receiver, or a portable storage device. Devices suitable for storing computer program instructions and data include non-volatile memory, media and memory devices, including, by way of example, semiconductor memory devices, magnetic disks, and magneto-optical disks. The processor and the memory can be supplemented by, or incorporated in, special-purpose logic circuitry.

Mobile devices can include handsets, user equipment (UE), mobile telephones (for example, smartphones), tablets, wearable devices (for example, smart watches and smart eyeglasses), implanted devices within the human body (for example, biosensors, cochlear implants), or other types of mobile devices. The mobile devices can communicate wirelessly (for example, using radio frequency (RF) signals) to various communication networks (described below). The mobile devices can include sensors for determining characteristics of the mobile device's current environment. The sensors can include cameras, microphones, proximity sensors, GPS sensors, motion sensors, accelerometers, ambient light sensors, moisture sensors, gyroscopes, compasses, barometers, fingerprint sensors, facial recognition systems, RF sensors (for example, Wi-Fi and cellular radios), thermal sensors, or other types of sensors. For example, the cameras can include a forward- or rear-facing camera with movable or fixed lenses, a flash, an image sensor, and an image processor. The camera can be a megapixel camera capable of capturing details for facial and/or iris recognition. The camera along with a data processor and authentication information stored in memory or accessed remotely can form a facial recognition system. The facial recognition system or one-or-more sensors, for example, microphones, motion sensors, accelerometers, GPS sensors, or RF sensors, can be used for user authentication.

To provide for interaction with a user, embodiments can be implemented on a computer having a display device and an input device, for example, a liquid crystal display (LCD) or organic light-emitting diode (OLED)/virtual-reality (VR)/augmented-reality (AR) display for displaying information to the user and a touchscreen, keyboard, and a pointing device by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments can be implemented using computing devices interconnected by any form or medium of wireline or wireless digital data communication (or combination thereof), for example, a communication network. Examples of interconnected devices are a client and a server generally remote from each other that typically interact through a communication network. A client, for example, a mobile device, can carry out transactions itself, with a server, or through a server, for example, performing buy, sell, pay, give, send, or loan transactions, or authorizing the same. Such transactions may be in real time such that an action and a response are temporally proximate; for example an individual perceives the action and the response occurring substantially simultaneously, the time difference for a response following the individual's action is less than 1 millisecond (ms) or less than 1 second (s), or the response is without intentional delay taking into account processing limitations of the system.

Examples of communication networks include a local area network (LAN), a radio access network (RAN), a metropolitan area network (MAN), and a wide area network (WAN). The communication network can include all or a portion of the Internet, another communication network, or a combination of communication networks. Information can be transmitted on the communication network according to various protocols and standards, including Long Term Evolution (LTE), 5G, IEEE 802, Internet Protocol (IP), or other protocols or combinations of protocols. The communication network can transmit voice, video, biometric, or authentication data, or other information between the connected computing devices.

Features described as separate implementations may be implemented, in combination, in a single implementation, while features described as a single implementation may be implemented in multiple implementations, separately, or in any suitable sub-combination. Operations described and claimed in a particular order should not be understood as requiring that the particular order, nor that all illustrated operations must be performed (some operations can be optional). As appropriate, multitasking or parallel-processing (or a combination of multitasking and parallel-processing) can be performed.

What is claimed is:

1. A computer-implemented method, comprising:
receiving a refund request for an international transaction;
in response to receiving the refund request, retrieving previously-stored exchange rate information for the international transaction associated with the refund request, wherein the exchange rate information includes an exchange rate between a foreign currency and a national currency that was in effect when the international transaction was originally processed;
calculating a refund amount for the international transaction based on the previously-stored exchange rate information;
processing the refund request for the international transaction based on the calculated refund amount.

2. The computer-implemented method of claim 1, wherein the exchange rate between the foreign currency and the national currency is set by an international e-commerce platform or by negotiation between a user and an international merchant.

3. The computer-implemented method of claim 1, wherein the refund request is a foreign currency refund request, and calculating the refund amount for the international transaction comprises:
converting a target amount of foreign currency into a corresponding amount of national currency based on the exchange rate information for the international transaction, wherein the target amount is the amount originally processed in a payment request for the international transaction.

4. The computer-implemented method of claim 1, wherein the refund request is a national currency refund request, and calculating the refund amount for the international transaction comprises:
converting a target amount of national currency into a corresponding amount of foreign currency based on the exchange rate information for the international transaction, wherein the target amount is the amount originally processed in a payment request for the international transaction.

5. The computer-implemented method of claim 3, wherein processing the refund request for the international transaction based on the calculated national currency amount comprises:
deducting the target amount of foreign currency from an account of an international merchant;
transferring the target amount of foreign currency to a predetermined foreign currency fund pool; and
returning the converted amount of national currency corresponding to the target amount of foreign currency by using an intermediate account.

6. The computer-implemented method of claim 4, wherein the processing the refund request for the international transaction based on the calculated national currency amount comprises:
deducting the converted amount of foreign currency corresponding to the target amount of national currency from an account of an international merchant;
transferring the converted amount of foreign currency corresponding to the target amount of national currency to a predetermined foreign currency fund pool; and
returning the target amount of national currency by using an intermediate account.

7. The computer-implemented method of claim 1, wherein processing the refund request for the international transaction comprises crediting an account specified in the refund request for the refund amount.

8. A non-transitory, computer-readable medium storing one or more instructions executable by a computer system to perform operations comprising:
receiving a refund request for an international transaction;
in response to receiving the refund request, retrieving previously-stored exchange rate information for the international transaction associated with the refund request, wherein the exchange rate information includes an exchange rate between a foreign currency and a national currency that was in effect when the international transaction was originally processed;
calculating a refund amount for the international transaction based on the previously-stored exchange rate information;
processing the refund request for the international transaction based on the calculated refund amount.

9. The computer-readable medium of claim 8, wherein the exchange rate between the foreign currency and the national currency is set by an international e-commerce platform or by negotiation between a user and an international merchant.

10. The computer-readable medium of claim 8, wherein the refund request is a foreign currency refund request, and calculating the refund amount for the international transaction comprises:
converting a target amount of foreign currency into a corresponding amount of national currency based on the exchange rate information for the international transaction, wherein
the target amount is the amount originally processed in a payment request for the international transaction.

11. The computer-readable medium of claim 8, wherein the refund request is a national currency refund request, and calculating the refund amount for the international transaction comprises:
converting a target amount of national currency into a corresponding amount of foreign currency based on the exchange rate information for the international transaction, wherein
the target amount is the amount originally processed in a payment request for the international transaction.

12. The computer-readable medium of claim 10, wherein the processing the refund request for the international transaction based on the calculated national currency amount comprises:
deducting the target amount of foreign currency from an account of an international merchant;
transferring the target amount of foreign currency to a predetermined foreign currency fund pool; and
returning the converted amount of national currency corresponding to the target amount of foreign currency by using an intermediate account.

13. The computer-readable medium of claim 11, wherein the processing the refund request for the international transaction based on the calculated national currency amount comprises:
deducting the converted amount of foreign currency corresponding to the target amount of national currency from an account of an international merchant;
transferring the converted amount of foreign currency corresponding to the target amount of national currency to a predetermined foreign currency fund pool; and
returning the target amount of national currency by using an intermediate account.

14. The computer-readable medium of claim 8, wherein processing the refund request for the international transaction comprises crediting an account specified in the refund request for the refund amount.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving a refund request for an international transaction;
in response to receiving the refund request, retrieving previously-stored exchange rate information for the international transaction associated with the refund request, wherein the exchange rate information includes an exchange rate between a foreign currency and a national currency that was in effect when the international transaction was originally processed;
calculating a refund amount for the international transaction based on the previously-stored exchange rate information;
processing the refund request for the international transaction based on the calculated refund amount.

16. The computer-implemented system of claim 8, wherein the exchange rate between the foreign currency and the national currency is set by an international e-commerce platform or by negotiation between a user and an international merchant, wherein processing the refund request for the international transaction comprises crediting an account specified in the refund request for the refund amount.

17. The computer-implemented system of claim 8, wherein the refund request is a foreign currency refund request, and calculating the refund amount for the international transaction comprises:
converting a target amount of foreign currency into a corresponding amount of national currency based on the exchange rate information for the international transaction, wherein
the target amount is the amount originally processed in a payment request for the international transaction.

18. The computer-implemented system of claim 8, wherein the refund request is a national currency refund request, and calculating the refund amount for the international transaction comprises:
converting a target amount of national currency into a corresponding amount of foreign currency based on the exchange rate information for the international transaction, wherein
the target amount is the amount originally processed in a payment request for the international transaction.

19. The computer-implemented system of claim 10, wherein the processing the refund request for the international transaction based on the calculated national currency amount comprises:
deducting the target amount of foreign currency from an account of an international merchant;
transferring the target amount of foreign currency to a predetermined foreign currency fund pool; and
returning the converted amount of national currency corresponding to the target amount of foreign currency by using an intermediate account.

20. The computer-implemented system of claim 11, wherein the processing the refund request for the international transaction based on the calculated national currency amount comprises:
deducting the converted amount of foreign currency corresponding to the target amount of national currency from an account of an international merchant;
transferring the converted amount of foreign currency corresponding to the target amount of national currency to a predetermined foreign currency fund pool; and
returning the target amount of national currency by using an intermediate account.
